(19) United States
(12) Patent Application Publication
(10) Pub. No.: US 2008/0015926 A1
(43) Pub. Date: Jan. 17, 2008

(54) Gradient Based Optimization of Fare Prices and Travel Parameters

(75) Inventor: Carl De Marcken, Seattle, WA (US)

Correspondence Address: FISH & RICHARDSON PC, P.O. BOX 1022, MINNEAPOLIS, MN, 55440-1022, US

(73) Assignee: ITA SOFTWARE, INC.

(21) Appl. No.: 11/743,714

(22) Filed: May 3, 2007

Related U.S. Application Data
(60) Provisional application No. 60/798,114, filed on May 4, 2006.

(51) Int. Cl. G06Q 50/00; G06F 17/18; G06Q 10/00

(52) U.S. Cl. 705/10

(57) ABSTRACT

Computer implemented techniques of revenue management for travel providers such as for airlines includes determining profit corresponding to an expected profit for a trip, where expected profit is over a solution chosen by a traveler are disclosed.

This application claims priority under 35 U.S.C. §119 to U.S. Provisional Patent Application Ser. No. 60/798,114, filed May 4, 2006, and entitled “Gradient Based Optimization of Fare Prices and Travel Parameters”, the entire contents of which are hereby incorporated by reference.

### BACKGROUND

This invention related to airlines revenue management tools.

A travel planning system makes use of many types of information including scheduling, faring, and availability data. The scheduling data describes where and when a passenger may travel; the faring data defines how much a given travel itinerary will cost; and the availability data describes the travel provider's willingness to sell the travel for the given cost.

The availability data is often affected by the travel provider's capacity and their prior sales of similar products at similar prices, and is analogous to report on remaining inventory. Airlines execute revenue management tools to optimize prices in order to maximize profit. So called Revenue Management Systems (RMS) are a tool to optimize an airline's revenues per flight. A revenue management system typically includes pricing and seat inventory control. Pricing involves fare classes and tariffs within those classes for each flight, whereas seat inventory control involves a periodic adjustment of available seats for the various fare classes so as to optimize passenger mix and maximize generated revenue.

One technique to take into consideration competition in management of RMS systems involves building predictors of competitor's RMS systems, as disclosed in PCT Application WO 02/06923 A2 published Jan. 24, 2002.

### SUMMARY

According to an aspect of the present invention, a computer implemented method of revenue management for travel providers includes determining profit corresponding to an expected profit for a trip, where expected profit is over a solution chosen by a traveler.

The following are embodiments within the scope of the invention. The method includes determining whether raising fares will increase the direct profit of a particular solution or lower the probability that that solution is chosen and thus lowering direct profit for the particular solution. Determining determines whether a traveler will avoid a high-prices answer because of the existence of a viable alternative to the expected trip. Determining explicitly takes into consideration, the effect that a price increase has on lowering the probability that a solution is chosen, and available competition for the chosen solution. Determining uses a pricing graph representation of travel solutions and extracts the solution chosen by the traveler for the pricing graph. Determining includes computing a derivative of overall profit with respect to individual fares using a pricing graph representation of travel solutions. Determining operates over multiple solutions from a search result represented by a pricing graph. The method computes trips for airline travel.

According to an additional aspect of the present invention, a computer program product residing on a computer readable medium for revenue management for travel providers comprises instructions for causing a machine to determine profit corresponding to an expected profit for a trip, where expected profit is over a solution chosen by a traveler.

The following are embodiments within the scope of the invention.

The computer program product further includes instructions to determine whether raising fares will increase the direct profit of a particular solution or lower the probability that that solution is chosen and thus lowering direct profit for the particular solution. The computer program product further includes instructions to determine whether a traveler will avoid a high-priced answer because of the existence of a viable alternative to the expected trip. The computer program product further includes instructions to determine explicitly the effect that a price increase has on lowering the probability that a solution is chosen given any available competition for the chosen solution.

According to an additional aspect of the present invention, apparatus includes a processor and a storage medium storing a computer program product for revenue management for travel providers, the computer program product including instructions for causing the processor to determine profit corresponding to an expected profit for a trip, where expected profit is over a solution chosen by a traveler.

The apparatus has the computer program products further including instructions to determine whether raising fares will increase the direct profit of a particular solution or lower the probability that that solution is chosen and thus lowering direct profit for the particular solution. The apparatus has the computer program product further including instructions to determine whether a traveler will avoid a high-priced answer because of the existence of a viable alternative to the expected trip. The apparatus has the computer program product further including instructions to determine explicitly, the effect that a price increase has on lowering the probability that a solution is chosen given any available competition for the chosen solution.

One or more aspects of the invention may provide one or more of the following advantages.

While raising fares may increase the direct profit of a particular solution, raising fares also likely lowers the probability that that solution is chosen, because consumers shy away from high-prices answers when there is a viable alternative. Thus, the effect that an increase in prices has on lowering the probability that a solution is chosen, depends on available competition. This aspect of revenue management by determining expected profit over a solution chosen by the traveler, explicitly takes into consideration the effect that competition has on prices. In a situation where a solution has no viable competitor solution, except “do not fly”, one can raise prices to increase profit with more impunity than if there are other good solutions. An optimization framework explicitly takes into consideration the effect that a price increase has on lowering the probability that a solution is chosen given any available competition for the chosen solution.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows a system for purchasing a ticket.

FIG. 2 shows a system for optimizing fare prices and travel parameters.

FIG. 3 shows a flow chart of the fare price optimization.

FIG. 4 shows a flow chart of details of fare price optimization.

### DETAILED DESCRIPTION

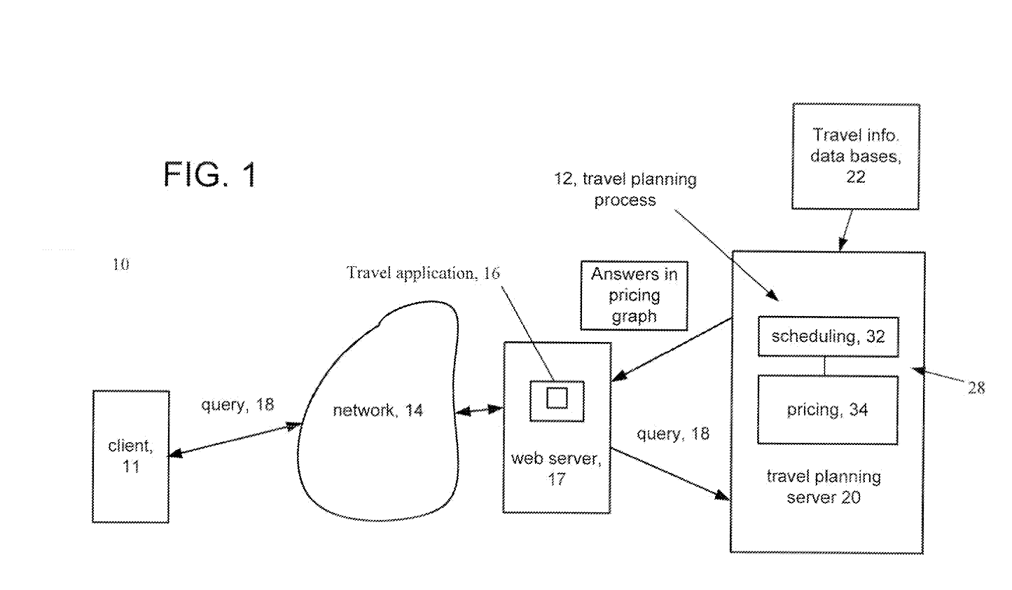

Referring to FIG. 1, an arrangement 10 for travel planning includes a travel planning process 12 to process queries sent from a client system 11. A user such as a traveler, travel agent or airline reservation agent enters trip information typically including date and airport (i.e. origin and destination) information from the client system 11 to a travel application 16 on a web server 17. The client 11 can run a browser connected to a travel web site, and so forth. Queries from the client system 11 are fed via a network 14 to the travel application 16. Network 14 can be any type of network such as a local area network (LAN), wide area network (WAN), virtual private network (VPN), and so forth. The travel application 16 typically resides on a web server 17.

The travel application 16 sends the queries 18 to a travel planning server 20 and, organizes the results from the travel planning server 20 into formatted output such as HTML, and sends the results back to client 11. The travel application 16 composes query information into an appropriately formatted query, e.g., a low-fare-search query, which is sent to the travel planning system 20.

The travel planning system 20 includes a search engine or search process 28 including scheduling process 32 and faring (or pricing) process 34. The search engine 28 searches for flight and fare combinations that satisfy the query. The search performed by the search engine 28 in the travel planning system 20 can use any of the several known techniques. The travel planning server 20 accesses information in travel information databases 22 that can be local or remote. An exemplary technique for implementing a travel planning system is disclosed in U.S. Pat. No. 6,295,521, by Carl G. deMarcken et al., filed Jul. 2, 1998, as U.S. application Ser. No. 09/109,327, assigned to the assignee of the instant application, the contents of which are incorporated herein by reference in its entirety.

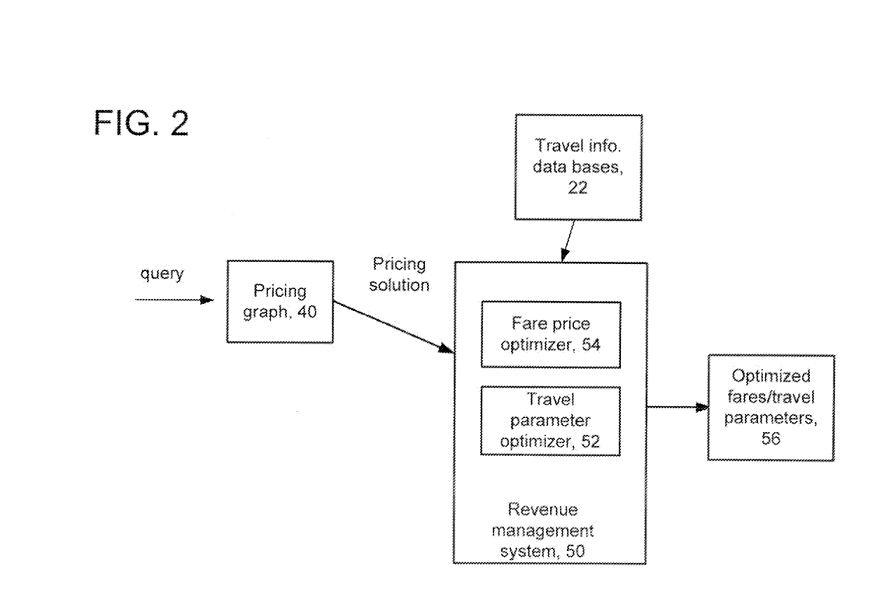

Referring now to FIG. 2, one technique to produce travel options (also referred to as travel solutions) as described in the above application is to represent the travel options in a compact representation known as pricing graph 40. As depicted in one implementation a pricing solution is fed to a revenue management system 50 of an e.g., airline. The revenue management system 50 includes a travel parameter optimizer 52 and fare price optimizer 54. These optimizers 52, 54 are typically computer programs that execute on a server computer (not explicitly shown) that provides the revenue management system 50. Resulting from the revenue management system 50 are optimized fare/travel parameters 56 that can be used in answering availability queries.

The disclosed revenue management system 50 determines profit roughly corresponding to an expected profit for each trip, where the expectation is over the solution chosen by the traveler.

While raising fares may increase the direct profit of a particular solution, raising fares also likely lowers the probability that that solution is chosen, because consumers shy away from high-priced answers when there is a viable alternative. Thus, the effect that an increase in prices has on lowering the probability that a solution is chosen, depends on available competition.

In a situation where a solution has no viable competitor solution, except “do not fly”, one can raise prices to increase profit with more impunity than if there are other good solutions. The optimization framework explicitly takes into account the effect that a price increase has on lowering the probability that a solution is chosen and considering the available competition for the chosen solution.

With the technique that uses a pricing graph representation of travel solutions, with certain probability distributions, the optimization computes the derivative of overall profit with respect to individual fares using the price graph representation. Unlike prior revenue management schemes that focus on historical usages, this revenue management takes consumer choice and competition into account, explicitly and exactly. The revenue management system 50 considers many possible solutions to a search (namely, those represented by the pricing graph 40) rather than just a few simple possibilities.

The pricing graph 40 makes it relatively easy and computationally inexpensive to enumerate solutions. As explained in the above patent, such solutions can be enumerated from the pricing graph using various value functions. The compactness and relative care of enumerating such solutions makes it an appropriate vehicle for holding pricing solutions that may be or that will be selected by the user.

The pricing graph 40 is a directed acyclic graph (DAG) that represents in a compact manner the set of pricing solutions 38, since in general, the number of nodes needed to represent a typical pricing solution will be substantially less than the actual number of pricing solutions represented by the DAG. This significantly increases the efficiency of transfer of a set of pricing solutions from the server process to the client process in the travel planning application context of the above referenced patent. Additionally, this compactness can also be used to advantage by the revenue management system 50 to take consumer choice and competition into account when arriving at seat availability determinations.

The DAG representation also minimizes the storage requirements for the set of pricing solutions. The DAG representation permits the use of powerful search, sorting and manipulation processes to product various subsets of set of pricing solutions in an efficient manner. As used herein, a directed acyclic graph (DAG) is a set of nodes connected by directed arcs, which have no loops of arcs in the same direction. If a node A is connected to a node B via an arc A→B, then A is called a parent of B, and B is called a child of A. Each node may have zero, one or many parents and zero, one or many children.

The pricing graph thus represents a set of pricing solutions in a compact representation, as a data structure comprising a plurality of nodes including itineraries and fares and that can be logically manipulated using value functions to enumerate a set of pricing solutions, as described in the above mentioned patent.

The pricing graph 40 represents pricing solutions and includes three types of nodes. The first type of node is an exclusive node, i.e., “OR” node. An OR node N with children A, B and C represents an exclusive choice between A, B and C. In other words, a pricing-solution involving node N contains either the fares and itineraries represented by A, or by B, or by C. The second type of node is a collection node, i.e., an “AND” node. An AND node N with children A, B and C represents the sum of A, B and C. In other words, a pricing solution involving N contains all the fares and itineraries found within A, B and C. The third type of node is a terminal node. Terminal nodes are used to hold pricing objects. Pricing objects include fares, itineraries, surcharges, routes, prices, booking codes, taxes, rules/restrictions and other information of the user or information that might be a part of a travel option. Collectively, “AND” and “OR” nodes are non-terminal nodes.

The pricing-graph encodes the requirement that two itineraries are combined , one from slice 1 and one from slice 2, to form a pricing solution. Further, each itinerary is spanned by fares. In this case each pricing solution involves two fares, and round-trip fares are combined with like round-trip fares. In most circumstances, the number of nodes in the pricing-graph is small compared to the number of pricing-solutions those nodes represent. In many cases, a graph of, e.g., 10,000 or so nodes can represent more than e.g., 1,000,000,000 pricing-solutions.

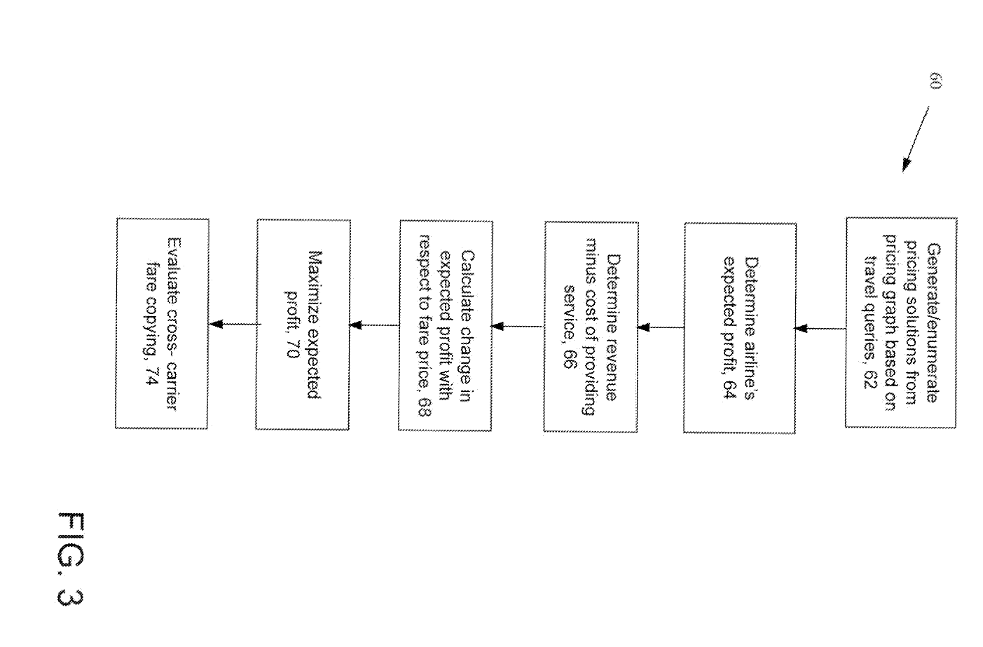

Referring now to FIG. 3, process 60 generates or enumerates pricing solutions from pricing graph based on travel queries 62. The process 60 determines 64 an airline's “α” expected profit, 64. The process 60 determines 66 expected profit, as the total revenue minus cost of providing the service. The process 60 calculates 68 changes in expected profit with respect to fare price. The process 60 maximizes expected profit 70 and evaluates 74 potential from cross-carrier fare copying.

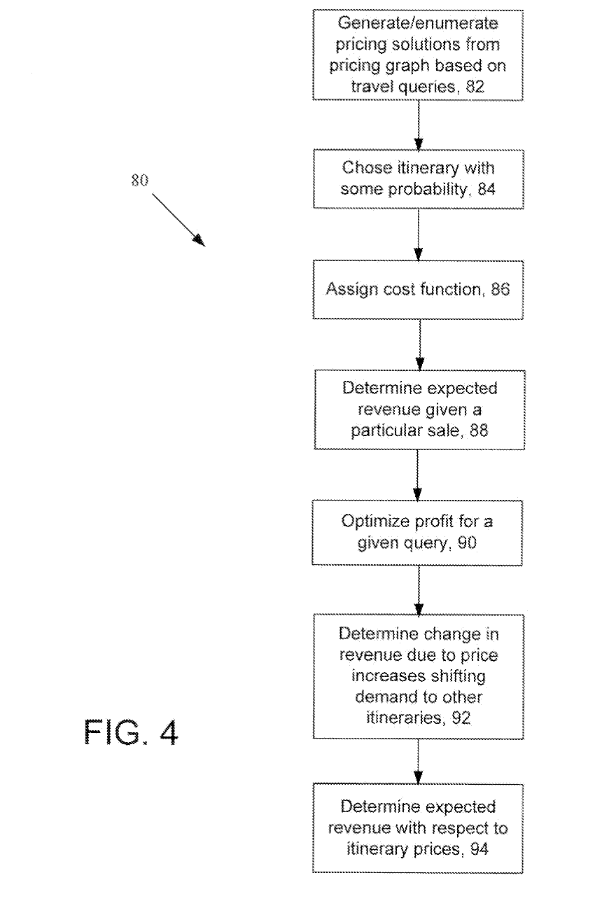

Referring now to FIG. 4, process 80 generates or enumerates 82 (as in the above mentioned patent) pricing solutions from pricing graph based on travel queries. The process 80 chooses 84 an itinerary from a set of enumerated itineraries based on some probability or likelihood that the traveler will be interested in the itinerary, e.g., various factors such as cost of the itinerary, convenience of the itinerary, number of stops, etc. can be considered. In other words a ranking or probability is assigned to the itinerary based on how close it corresponds to parameters specified by the traveler in a travel planning query. The process 80 also assigns 86 a cost function to the itinerary. The process determines 88 an expected revenue given a particular sale based on that itinerary. The process optimizes 80 the price for a given query based on the itinerary. The process determines 92 any change in revenue resulting from a price increase that would shift demand to other itineraries. The process 80 determines 94 the expected revenue with respect to itinerary prices.

The process thus models purchasing a ticket “M” as follows:

A trip “t={q, c, w)” is chosen (e.g., 82 FIG. 4) according to the distribution p(t), where q is a query, c is a sales channel, and w is a set of optimization parameters that determine which solutions best fit the passenger's needs. The set of solutions S(c, q) presented to the passenger ∈ for the query is a function of the sales channel. The passenger selects a solution s ∈ S based on w. (As used in the description herein the symbol ∈ corresponds to the symbol appearing in the formulas and indicates a member of.)

Under this model, an airline's expected profit (e.g., 64 FIG. 3) “Profit_{α}” for a single trip can be written in terms of the profit the airline makes on a particular solution, profit_{α} (s):

$$\begin{matrix}{Profit}_{a} = {E}_{t} [ {Profit}_{a} ( t ) ] \\ = {\sum }_{t = 〈 q , c , w 〉 ∈ T} p ( t ) {Profit}_{a} ( t ) ; \\ {Profit}_{a} = {E}_{s \vert t} [ {profit}_{a} ( s ) ] \\ = {\sum }_{s ∈ S ( c , q )} p ( s \vert w , S ( c , q ) ) {profit}_{a} ( s ) .\end{matrix} \qquad \begin{matrix}\begin{matrix}\begin{matrix}\begin{matrix}\begin{matrix}( 1 ) \\ ( 2 )\end{matrix} \\ \end{matrix} \\ ( 3 )\end{matrix} \\ ( 4 )\end{matrix} \\ \end{matrix}$$

Assume that p(s|w, S(c, q)) is a Boltzmann distribution with energy determined by the price of s, y(s), and various other properties summarized in a vector of values v(s). In particular, let w={w*, w^{v}) where w* is a distinguished price weight and w^{v} is a vector of ordinary weights, and model p(s|w, S) by:

$$p ( s \vert w , S ) = \frac{{ⅇ}^{{w}^{*} y ( s ) + {w}^{v} \cdot v ( s )}}{{\sum }_{{s}^{′}} {ⅇ}^{{w}^{*} y ( {s}^{′} ) + {w}^{v} \cdot v ( {s}^{′} )}} . \qquad ( 5 )$$

Indexing fares with i, the price y(s) is assumed to be an independent sum y(s)=Σᵢnᵢ(s)φ(fᵢ, s) where nᵢ(s) is the number of occurrences of fare i in s and Φ(fᵢ,s) is the total price of fare i given a published fare price fᵢ as controlled by the airline.

$$\begin{matrix}y ( s ) = {\sum }_{i} {n}_{i} ( s ) ϕ ( {f}_{i} , s ) \\ = {\sum }_{i} {n}_{i} ( s ) {ϕ}_{i} ( s ) {f}_{i} \\ = {n}^{′} ( s ) \cdot f .\end{matrix} \qquad \begin{matrix}\begin{matrix}\begin{matrix}\begin{matrix}( 6 ) \\ \end{matrix} \\ ( 7 )\end{matrix} \\ \end{matrix} \\ ( 8 )\end{matrix}$$

The function Φ is used to account for taxes and other discrepancies between the prices under airline's control and the prices visible to passengers. For simplicity assume Φ is a simple multiplicative factor: Φ (fᵢ, s)=Φᵢ (s)fᵢ, and move the Φᵢ (s) into a revised n′ᵢ (s) count:

The profit an airline “α” receives for a solution is the revenue minus the cost of providing the service. This assumes the capacity constraints do not prevent further sales. One way around this problem is to take the capacity constraints into account when computing cost(s), for example using the usual cost from linear programming.
profit_{α}(s)=n(s)·δ_{α}f−cost(s) (9)

where δ_{α} is 1 if the fare is published by an airline “α” and “0” otherwise. From these equations one can calculate the change in expected profit (e.g., 68 FIG. 3) with respect to fare price as:

$$\begin{matrix}\frac{\partial y ( s )}{\partial {f}_{i}} = {n}_{i}^{′} ( s ) ; \\ \frac{\partial p ( s \vert w , S )}{\partial {f}_{i}} = p ( s \vert w , S ) {w}^{*} [ \frac{\partial y ( s )}{\partial {f}_{i}} - {E}_{s \vert t} [ \frac{\partial y ( s )}{\partial {f}_{i}} ] ] ; \\ = p ( s \vert w , S ) {w}^{*} [ {n}_{i}^{′} ( s ) - {E}_{s \vert t} [ {n}_{i}^{′} ( s ) ] ] ; \\ \frac{\partial {profit}_{a} ( s )}{\partial {f}_{i}} = {n}_{i} ( s ) {δ}_{i}^{a} ; \\ \frac{\partial {Profit}_{a} ( t )}{\partial {f}_{i}} = {\sum }_{s ∈ S} p ( s \vert w , S ) {n}_{i} ( s ) {δ}_{i}^{a} + \\ p ( s \vert w , S ) {w}^{*} ( {n}_{i}^{′} ( s ) - {E}_{s \vert t} [ {n}_{i}^{′} ( s ) ] ) {profit}_{a} ( s ) \\ = {E}_{s \vert t} [ {n}_{i} ( s ) {δ}_{i}^{a} + {w}^{*} ( {n}_{i}^{′} ( s ) - {E}_{s \vert t} [ {n}_{i}^{′} ( s ) ] ) {profit}_{a} ( s ) ] \\ = {E}_{s \vert t} [ {n}_{i} ( s ) {δ}_{i}^{a} ] + {w}^{*} {E}_{s \vert t} [ {n}_{i}^{′} ( s ) {profit}_{a} ( s ) ] - \\ {w}^{*} {E}_{s \vert t} [ {n}_{i}^{′} ( s ) ] {E}_{s \vert t} [ {profit}_{a} ( s ) ] ; \\ \frac{\partial {Profit}_{a} ( t )}{\partial {f}_{i}} = {E}_{t} [ \frac{\partial {profit}_{a} ( s )}{\partial {f}_{i}} ] .\end{matrix} \qquad \begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}( 10 ) \\ \end{matrix} \\ ( 11 )\end{matrix} \\ \end{matrix} \\ ( 12 )\end{matrix} \\ \end{matrix} \\ ( 13 )\end{matrix} \\ \end{matrix} \\ ( 14 )\end{matrix} \\ \end{matrix} \\ ( 15 )\end{matrix} \\ ( 16 )\end{matrix} \\ \\ ( 17 )\end{matrix}$$

The expectation over a trip “t” in equation 17 can be calculated using sampling. For instance, queries are sampled from p(q) and pricing graphs g(q) generated. Samples of w, c are taken from p(w, c|q)=p(w, c, q)/p(q).

To compute the terms of equation 16, these terms are calculated by enumerating the set of solutions S(c, q) from g(q), but that may be somewhat expensive, if the sales channel “c” affects S(c, q) in a manner that factors over the graph, and likewise the cost(s) and n′ᵢ(s) factor. In that situation, the forms of the terms in equation 16 allow those terms to be calculated for all “i” using dynamic programming directly on g(q), in time proportional to |g(q)| and independent of the number of fares. This is because under the factored Boltzmann distribution it is possible to use “up/down” to calculate the expect number of times a node appears in a solution (Eₛ|ₜ[nᵢ(s) δ^{α}ᵢ] and E_{s|i}[n′ᵢ(s)], as well as, the expected total value of any solution involving a node E_{s|t}[profit (s)]. “Up/down” refers to “ascending or descending hill climbing algorithm, discussed bellow, which is used to test for inflexion points on a surface or function. That is, profit is estimated in the solving of Equation 17. The values for parameters are incremented and re-computer. If there is a change in slope another value is tested to determine if the slope has changed more or less. The iterations continue until adding a small increment to the parameter in questions marks no change in slope (gradient), indicating a maxima (or minima).

For the non-linear term E_{s|t}[profit_{α} (s)] the discrete nature of n′ᵢ(s) allows that term to be calculated by maintaining for each graph node a vector of values indexed by n′ᵢ.

The gradient equation 17 can be used with iterative hill climbing (or other iterative, accelerated search algorithms) to maximize expected profit. The pricing graphs do not need to be recalculated for successive iterations and the calculation is parallelizable. For instance, if it takes 0.01 seconds to evaluate equation 16 for all fares for a particular t, then for 100,000 queries and 100 (w, c) combinations and 10 computers it takes 10,000 seconds (3 hours) per iteration. This assumes that all price related pruning has been turned off in the original pricing graph construction, so that the pricing graphs do not need to be recalculated.

Cross-carrier fare copying (e.g., 74 FIG 3) can be handled by simply sharing parameters for these fares that are believed to move in unison. The algorithm above calculates profit derivatives for all airlines with respect to all fares. This has the advantage of:
sharing work if optimization is to be done for multiple carriers;
gauging the result of changes on competitor's profits; and
determining vulnerability of one airline to another's actions.

To explore the effects of altering prices at a finer grain that the current fare database (for example, splitting prices by morning or evening, or for different advanced purchases or travel dates) the pricing graph generator is modified to generate virtual fares.

Flight capacity (e.g., the number of seats available on a particular flight) at time t is given by N (t)={n(l,t)|I C L), the number of seats sold every flight. During every time step [t, t+dt] some random number c(q, t, dt) of each kind of query q ∈ Q arrives. Here is a query taken to be a tuple q=(w, u, h), where w represents such trip-related information as desired origins, designations and times, u is a hidden choice parameter that controls the querier's tradeoff of price and convenience and h is a sales channel indicator that determines the space of itineraries presented as choices. For each query q=(w, u, h) some set of (single-airline) itineraries I(q)=I(w, h) ⊂l is presented to the querier (e.g., 82 FIG. 4). Each itinerary t ∈ l(q) is assigned a price z_{α(i)}(i, N(t), (t)) by the itineraries airline “ai”.

On the basis of these prices and the fit of each “i” to the query q=(w, u, h), the querier chooses (e.g., 84 FIG. 4) an itinerary with some probability p(i|q, N(t), t). For example, the choice function might a Boltzmann distribution.

$$p ( i \vert q , N ( t ) , t ) = \frac{{ⅇ}^{- f ( ⅈ , , q , N ( t ) , t )}}{{\sum }_{j ∈ I ( w , h )} {ⅇ}^{- f ( j , q , N ( t ) , t )}} \qquad ( 18 )$$

where each itinerary is assigned a cost f(e.g., 76 FIG. 4) given by:
f(i, q, N(t), t)=π(u)a_{α(t)}(t, N(t), t)+κ(i, ω, u) (19)

Here f linearly combines each itinerary's price z_{α(i)} with it convenience as measured by a query specific price sensitivity coefficient π(u) and query-specific convenience coefficient κ(i, w, u), e.g., cost functions, (e.g., 86 FIG. 4). The set of itineraries “l” is assumed to contain a special itinerary i* representing “no travel,” which is assigned a price of “0” but presumably high query-specific convenience coefficient κ. The special itinerary “i*” is part of every l(q) to insure that prices stay bounded.

On this basis, in the period [t, t+dt] some random number s(i, N(t), t, dt) of sales of each itinerary “i” takes place. The joint distribution of “s” depends on the joint distribution of the query counts but by linearity of expectations:

$$E [ s ( i , N ( t ) , t , dt ) ] = {\sum }_{q ∈ Q} p ( i \vert q , N ( t ) , t ) E [ c ( q , t , dt ) ] \qquad ( 20 )$$

For each sale of an itinerary i of a price z, airline α(i) realizes some revenue r_{αi}(i, z) which one may assume is a linear function of price:
r_{α}=_{α(i)}(i,z)=z−cost_{α}(i) (21)
r_{α≠α(i)}(i, z)=0 (22)

Let I_{α}(q)={i ∈ I(q)|α(i)=α}. Then the expected revenue (e.g., 88 FIG. 4) R_{α}(N(t), t, dt) for an airline “a” in |t,t+dt| is:

$$E [ {R}_{a} ( N ( t ) , t , dt ) ] = {\sum }_{q ∈ Q} {\sum }_{i ∈ {I}_{a} ( q )} {r}_{a} ( i , {z}_{a} ( i , N ( t ) , t ) ) p ( i \vert q , N ( t ) , t ) E [ c ( q , t , dt ) ] \qquad ( 23 )$$

Let M_{α} (N(t), t) denote the expected future revenue to airline “a” given sales N(t) at time t. By using linearity of expectations M_{α} (N(t), t) is as:
M_{α}(N(t), t)=E[R_{α}(N(t), t, dt)]+E[M_{α}(T(N(t), S(t, dt), t+dt)] (24)

where S(t,dt)={s(i, N(t), t, dt|i ∈ I} is the total sales for each itinerary with the time interval and the function T is a leg count transition function. Since M_{α} is a complicated function and S(t, dt) is a high-dimensional random variable E[M_{α}(T(N(t), S(t, dt), t+dt)] would be difficult to compute without making some assumptions.

Assuming that each airline sets prices to maximize their profits one might expect equilibrium where:

$$\frac{\partial {M}_{a} ( N ( t ) , t )}{\partial {z}_{a} ( i , N ( t ) , t )} = 0. \qquad ( 25 )$$

In order to find optimal profit (e.g., 90 FIG. 4), e.g., best price in a given query, the process below essentially finds the best prices for a given query z_{α}(i, N(t), t, q), whereas the formulation above assumes prices (at time t) are constant across queries z_{α}(I, N(t), t). The calculation of M is more computationally demanding if one allows z_{α}(i) to depend on q. The easiest way top act consistently with the calculation of M_{α}, would be to maintain a table z_{α}, (i, N(t), t) and use the table at query time.

Given a query “q”, the optimum price for an airline to set, for itineraries i ∈ l(q), assuming all airlines are playing the optimal strategy, is determined by maximizing M_{α}(N(t), t, q) for all airlines a ∈ A, where

$${M}_{a} ( N ( t ) , t , q ) = {\sum }_{i ∈ I ( q )} p ( i \vert q , N ( t ) , t ) {M}_{a} ( T ( N ( t ) , i ) , t , 0 ) \qquad ( 26 )$$

If the choice parameters u is hidden then Mₐ (N(t), t, q) is amended to q^{t}=(w, h) as in equation 27.

$$\begin{matrix}{M}_{a} ( N ( t ) , t , {q}^{′} ) = {\sum }_{u ∈ U} p ( u \vert w , h , t ) {\sum }_{i ∈ I ( {q}^{′} )} {M}_{a} ( T ( N ( t ) , t ) , t , 0 ) . & ( 27 ) \\ and & \\ {M}_{a} ( i , N ( t ) , t , dt ) = {r}_{a} ( i , {z}_{a} ( i , N ( t ) , t ) ) + {M}_{a} ( T ( N ( t ) , i ) , t + dt ) & ( 28 )\end{matrix}$$

This is an ordinary set of joint equations in itinerary prices, one per itinerary. Assuming the Boltzmann distribution given above,

$$\frac{\partial p ( j \vert q , N ( t ) , t )}{\partial {z}_{a ( t )} ( i )} = - π ( q ) p ( i \vert q , N ( t ) , t ) ( 1 - p ( t \vert q , N ( t ) , t ) )$$

$$\frac{\partial p ( j \vert q , N ( t ) , t )}{\partial {z}_{a ( t )} ( i )} = π ( u ) p ( i \vert q , N ( t ) , t ) p ( j \vert q , N ( t ) , t )$$

and therefore at equilibrium

$$\begin{matrix}\frac{\partial {M}_{a} ( N ( t ) , t , q )}{\partial {z}_{a} ( i , N ( t ) , t )} = {\sum }_{j ∈ I ( q )} \frac{\partial p ( j \vert q , N ( t ) , t )}{\partial {z}_{a} ( i < N ( t ) , t )} {M}_{a} ( j , N ( t ) , t , 0 ) + \\ p ( j \vert q , N ( t ) , t ) \frac{\partial {r}_{a} ( j , {z}_{a} ( j , N ( t ) , t ) )}{\partial {z}_{a} ( i , N ( t ) , t )} \\ = {\sum }_{j ∈ I ( q ) - 1} \frac{\partial p ( j \vert q , N ( t ) , t )}{\partial {z}_{a} ( i < N ( t ) , t )} {M}_{a} ( j , N ( t ) , t , 0 ) + \\ \frac{\partial p ( i \vert q , N ( t ) , t )}{\partial {z}_{a} ( i , N ( t ) , t )} {M}_{a} ( i , N ( t ) , t , 0 ) + \\ p ( i \vert q , N ( t ) , t ) \\ = p ( i \vert q , N ( t ) , t ) [ π ( u ) [ {\sum }_{j ∈ I ( q )} p ( j \vert q , N ( t ) , t ) \\ {M}_{a} ( j , N ( t ) , t , 0 ) - {M}_{a} ( i , N ( t ) , t , 0 ) ] + 1 ] \\ = 0.\end{matrix}$$

This can be solved at query time using any of the normal iterative methods to determine the optimal prices to offer.

Suppose dt is sufficiently small that either exactly one query or no queries are received in dt. Then p(q, t, dt) replaces c(q, t, dt) and

$$\begin{matrix}\begin{matrix}{M}_{a} ( N ( t ) , t ) = \overline{p} {M}_{a} ( N ( t ) , t + d t ) + {\sum }_{i ∈ I ( q )} p ( i , N ( t ) , t , d t ) \\ {M}_{a} ( i , N ( t ) , t , d t )\end{matrix} & ( 29 ) \\ where & \\ p ( i , N ( t ) , t , d t ) = {\sum }_{q ∈ Q} p ( q , t , d t ) p ( i \vert q , N ( t ) , t ) & ( 30 ) \\ \overline{p} = {\prod }_{q ∈ Q} ( 1 - p ( q , t , d t ) ) & ( 31 )\end{matrix}$$

computing partial derivatives

$$\begin{matrix}\frac{\partial {M}_{a} ( N ( t ) , t )}{\partial {z}_{a} ( i , N ( t ) , t )} = \begin{matrix}{\sum }_{j ∈ I} [ {M}_{a} ( j , N ( t ) , t , d t ) \frac{ \partial p ( j , N ( t ) , t , d t )}{\partial {z}_{ a} ( i , N ( t ) , t )} + \\ p ( j , N ( t ) , t , d t ) \frac{\partial {r}_{a} ( j , {z}_{a} ( j , N ( t ) , t ) )}{\partial {z}_{a} ( i , N ( t ) , t )} ]\end{matrix} \\ = \begin{matrix}{\sum }_{j ∈ I - 1} [ {M}_{a} ( j , N ( t ) , t , d t ) \frac{ \partial p ( j , N ( t ) , t , d t )}{\partial {z}_{ a} ( i , N ( t ) , t )} ] + \\ {M}_{a} ( i , N ( t ) , t , d t ) \frac{ \partial p ( i , N ( t ) , t , d t )}{\partial {z}_{ a} ( i , N ( t ) , t )} + \\ p ( i , N ( t ) , t , d t )\end{matrix}\end{matrix}$$

and assuming the Boltzmann distribution (discussed above):

$$\begin{matrix}\frac{\partial {M}_{a} ( N ( t ) , t )}{\partial {z}_{a} ( i , N ( t ) , t )} = {\sum }_{j ∈ I - 1} [ {M}_{a} ( j , N ( t ) , t , d t ) {\sum }_{q ∈ Q} π ( u ) p ( i \vert q , N ( t ) , t ) \\ p ( j \vert q , N ( t ) , t ) ] + - {M}_{a} ( i , N ( t ) , t , d t ) \\ {\sum }_{q ∈ Q} π ( u ) p ( i \vert q , N ( t ) , t ) ( 1 - p ( i \vert q , N ( t ) , t ) ) + \\ p ( i , N ( t ) , t , d t )\end{matrix}$$

The first term represents the change in revenue due to the price increase shifting demand to other itineraries (e.g., 92 FIG. 4). The second term represents the change in revenue due to the price increase decreasing demand on itinerary i. The final term represents the direct increase in revenue due to the higher price of itinerary i, (e.g., 94 FIG. 4).

Suppose M_{α}(N(t); t) is approximated as:

$${M}_{a} ( N ( t ) , t ) = {\sum }_{i ∈ l} {M}_{a}^{i} ( n ( i , t ) , t ) \qquad ( 32 )$$

where n(i, t) is the number of sales of itineraries i at time t2. This approach also can be applied to decomposition of pricing solution over legs rather than itineraries, as discussed. Then

$$\begin{matrix}{M}_{a} ( N ( t ) , t ) = E [ {R}_{a} ( N ( t ) , t , d t ) ] + E [ {M}_{a} ( T ( N ( t ) , S ( t , d t ) ) , t + d t ) ] \\ = \begin{matrix}E [ {R}_{a} ( N ( t ) , t , d t ) ] + E [ {\sum }_{j ∈ I} {M}_{a}^{j} ( n ( j , t ) + \\ s ( j , N ( t ) , t , d t ) , t + d t ) ]\end{matrix} \\ = \begin{matrix}E [ {R}_{a} ( N ( t ) , t , d t ) ] + {\sum }_{j ∈ I} E [ {M}_{ a}^{ j} ( n ( j , t ) + \\ s ( j , N ( t ) , t , d t ) , t + d t ) ]\end{matrix} \\ = \begin{matrix}{\sum }_{j ∈ I} {\sum }_{kj} p ( s ( j , … ) = {k}_{j} ) [ {k}_{j} {r}_{a} ( j , {z}_{a} ( j , N ( t ) , t ) ) + \\ {M}_{ a}^{ j} ( n ( j , t ) + {k}_{j} , t + d t ) ]\end{matrix}\end{matrix}$$

$$\begin{matrix}\frac{\partial {M}_{a} ( N ( t ) , t )}{\partial {z}_{a} ( i , N ( t ) , t )} = {\sum }_{j ∈ I} {\sum }_{kj} \frac{\partial p ( s ( j , … ) = {k}_{j} )}{\partial {z}_{a} ( i , N ( t ) , t )} [ {k}_{j} {r}_{a} ( j , {z}_{a} ( j , N ( t ) , t ) ) + \\ {M}_{ a}^{ j} ( n ( j , t ) + {k}_{j} , t + d t ) ] + E [ s ( i , … ) ] .\end{matrix}$$

In this way there is no longer a need to perform a summation over the joint space of seat changes so long as the marginal distribution of s(i, N(t), t, dt) can be computed. Assuming that each type of query q is an independent Poisson process with arrival rate λ_{q}, (t), such that t p (c(q,t,dt)=k)=:

$$\begin{matrix}{P}^{k} ( {λ}_{q} ( t ) d t ) where {P}^{k} ( μ ) \vert = \frac{{μ}^{k} {ⅇ}^{- μ}}{k} and {P}^{k} ( μ ) = \frac{\partial {P}^{k} ( μ )}{\partial μ} = \\ {P}^{k} ( μ ) ( \frac{k}{μ} - 1 )\end{matrix}$$

then s(t, . . . ) is also Poisson with arrival rate λ_{q}, (N(t), t)=Σ_{qεQ}λ_{q}(t)p(i|q, N(t), t) and

$$\begin{matrix}\frac{\partial p ( s ( j , N ( t ) , t ) = k )}{\partial {z}_{a} ( i , N ( t ) , t )} = {P}^{k} ( {λ}_{j} ( N ( t ) , t ) d t ) \frac{\partial {λ}_{i} ( N ( t ) , t ) d t}{\partial {z}_{a} ( i , N ( t ) , t )} \\ = \begin{matrix}{P}^{ k} ( {λ}_{ j} ( N ( t ) , t ) d t ) {\sum }_{q ∈ Q} {λ}_{ q} ( t ) \\ \frac{\partial p ( j \vert q , N ( t ) , t )}{\partial {z}_{a} ( i , N ( t ) , t )} d t .\end{matrix}\end{matrix} \qquad ( 34 )$$

Therefore a relatively efficient way to compute the partial derivative of expected revenue is:

$$\begin{matrix}\frac{\partial {M}_{a} ( N ( t ) , t )}{\partial {z}_{a} ( i , N ( t ) , t )} = {\sum }_{j ∈ I} {\sum }_{kj} {P}^{k} ( {λ}_{j} ( … ) d t ) [ {k}_{j} {r}_{a} ( j , {z}_{a} ( j … ) ) + \\ {M}_{ a}^{ j} ( n ( j , t ) + {k}_{j} , t + d t ) ] {\sum }_{q ∈ Q} {λ}_{q} ( t ) \\ \frac{\partial p ( j \vert q , … )}{\partial {z}_{a} ( i , … )} a + {λ}_{j} ( … ) d t .\end{matrix}$$

This is a relatively efficient way to compute the partial derivatives of the expected revenue M_{Q}(M(t), t) with respect to itinerary prices.

The invention can be implemented as a computer program product residing on a computer readable medium. Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a compute will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of embodiments of the invention, or any combination of such back end, middleware, or front end components. The components of the system can be interconnected by any form or medium of digital data communication, e.g., a communication network. Examples of communication networks include a local area network (LAN) and a wide area network (WAN), e.g., the Internet.

A number of embodiments of the invention have been described. Nevertheless, it will be understood that various modifications may be made without departing from the spirit and scope of the invention. For example, the described technique could be modified to decompose over legs instead of itineraries. Since the state space includes a counts on all legs, even other airlines', it may not work as well for a case where only a particular airlines own counts are observable. Of course, even in single-airline version, the formulation of revenue management should be an improvement over formulations that ignore spillage. Price constraints could be incorporated on an airline's own prices as well as those of an airline's competitor. For instance one way to handle price constraints is that prices can only be drawn from some subset of prices, as determined in accordance with the original travel query. Also the process could handle price constraints, by requiring that prices are through the same or through different sales channels. The process could be simplified to cover single-slice itineraries rather that joint slices over outbound and return slices of a journey. Accordingly, other embodiments are within the scope of the following claims.

What is claimed is:

1. A computer implemented method of revenue management for travel providers, comprises:
determining profit corresponding to an expected profit for a trip, where expected profit is over a solution chosen by a traveler.

2. The method of claim 1 wherein
determining whether raising fares will increase the direct profit of a particular solution or lower the probability that a solution is chosen, lowering direct profit for the particular solution.

3. The method of claim 1 wherein determining further comprises:
determining whether a traveler will avoid a high-priced answer because of the existence a viable alternative to the expected trip.

4. The method of claim 1 wherein determining explicitly takes into consideration the effect that a price increase has on lowering the probability that a solution is chosen and available competition for the chosen solution.

5. The method of claim 1 wherein determining uses a pricing graph representation of travel solutions and extracts the solution chosen by the traveler from the pricing graph.

6. The method of claim 1 wherein determining comprises computing a derivative of overall profit with respect to individual fares using a pricing graph representation of travel solutions.

7. The method of claim 1 wherein determining operates over multiple solutions from a search result represented by a pricing graph.

8. The method of claim 1 wherein trips are trips for airline travel.

9. A computer program product residing on a computer readable medium for revenue management for travel providers comprises instructions for causing machine to:
determine profit corresponding to an expected profit for a trip, where expected profit is over a solution chosen by a traveler.

10. The computer program product of claim 9 further comprising instructions to:
determine whether raising fares will increase the direct profit of a particular solution or lower the probability that that solution is chosen and thus lowering direct profit for the particular solution.

11. The computer program product of claim 9 further comprising instructions to:
determine whether a traveler will avoid a high-priced answer because of the existence of a viable alternative to the expected trip.

12. The computer program product of claim 9 further comprising instructions to:
determine explicitly the effect that a price increase has on lowering the probability that a solution is chosen, and available competition for the chosen solution.

13. Apparatus comprising:
a processor; and
a storage medium storing a computer program product for revenue management for travel providers, the computer program product comprising instructions for causing the processor to:
determine profit corresponding to an expected profit for a trip, where expected profit is over a solution chosen by a traveler.

14. The apparatus of claim 13 wherein the computer program product further comprising instructions to:
determining whether raising fares will increase the direct profit of a particular solution or lower the probability that that solution is chosen and thus lowering direct profit for the particular solution.

15. The apparatus of claim 13 wherein the computer program product further comprising instruction to:
determine whether a traveler will avoid a high-priced answer because of the existence a viable alternative to the expected trip.

16. The apparatus of claim 13 wherein the computer program product further comprising instructions to:
determine explicitly the effect that a price increase has on lowering the probability that a solution is chosen, and available competition for the chosen solution.
